(19) United States
(12) Patent Application Publication
(10) Pub. No.: US 2015/0056860 A1
(43) Pub. Date: Feb. 26, 2015

(54) ELECTRICAL CONNECTING STRUCTURE HAVING AN ELECTRICAL CONNECTOR AND AN ELECTRICAL CONFIGURATION RELATING THERETO

(71) Applicant: ROBERT BOSCH GMBH

(72) Inventors: Werner Hofmeister, Ludwigsburg (DE); Martin Saur, Salach (DE); Markus Bahr, Waiblingen (DE); Markus Lux, Winnenden (DE)

(21) Appl. No.: 14/364,271

(22) PCT Filed: Oct. 15, 2012
(86) PCT No.: PCT/EP2012/070361

§ 371 Date: Jun. 10, 2014

(30) Foreign Application Priority Data
Dec. 13, 2011 (DE) 10 2011 088 333.9

(51) Int. Cl. H01R 13/6581; H01R 24/22

(52) U.S. Cl. CPC H01R 13/6581; H01R 24/22
USPC 439/607.45

(57) ABSTRACT

An electrical connecting structure having an electrical connector having an insulating connector housing that can be electroconductively connected to an electrical mating connector, which is permanently connected to an electrical unit, to permit the transmission of high currents. The connecting structure has a first and a second electrical line; these being adapted for transmitting a first phase angle and a second current at a first phase angle and at a second phase angle that is temporally offset therefrom. The first and second line have a corresponding first and second shield for protecting against electromagnetic interference. The first and second shield are detachably and electroconductively connectable to a corresponding third and fourth shield configured in the mating connector. The first and the second shield differ from one another and are electroconductively interconnected within the electrical connecting structure.

### BACKGROUND INFORMATION

It is common practice in the electric propulsion of modern motor vehicles, such as hybrid vehicles, for DC current to be fed to an inverter which is then used to transform the

DC current into a mostly three-phase AC current. This AC current is fed to a drive motor. Since high currents are carried on the lines that connect the inverter to the drive motor, these lines typically have a cross section of between 25 mm² and 50 mm². As these cables are relatively thick, it has proven to be effective for each phase to be fed separately by an individual electric line to the drive motor. Because the inverter induces strong electromagnetic interference into the line, a shield individually shields each line against electromagnetic interference leakage from the cable. The drive motor can be electroconductively connected to the inverter by an electrical plug connection. It is also customary for the shield of each individual line to be pluggably connected to that at the drive motor, the shields then being electroconductively interconnected within the drive motor.

However, it has been found that high interference currents act upon each shield during operation of the motor vehicle due to electromagnetic interference. The transition resistances within the electrical plug connection cause a considerable power loss to occur in conjunction with the high current intensities. This power loss, in turn, leads to a substantial heating of the plug connection and can thereby unacceptably load the plug connection. In order not to overheat the electrical plug connection, the current intensity carried by the electrical line is mostly suitably adapted or limited.

### SUMMARY

There may, therefore, be a need to provide an electrical connecting structure that will make it possible for the heat generated by the interference current in the shield to be reduced in the electrical plug connection.

In accordance with a first exemplary embodiment of the present invention, an electrical connecting structure having an electrical connector is provided with an electrically insulating connector housing. To permit the transmission of high currents, the electrical connecting structure is adapted for electroconductively connecting the electrical connector to an electrical mating connector that is permanently connected to an electrical unit. The connecting structure has a first electrical line, the first electrical line being adapted for conducting a first electric current at a first phase angle. The connecting structure has a second electrical line, the second electrical line being adapted for conducting a second electric current at a second phase angle. The first phase angle and the second phase angle are temporally offset from one another. The first line features a first shield for protecting against electromagnetic interference. The second line features a second shield for protecting against electromagnetic interference. The first shield is detachably and electroconductively connectable to a third shield configured in the mating connector. The second shield is detachably and electroconductively connectable to a fourth shield configured in the mating connector. The first shield and the second shield differ from one another. The first shield and the second shield are electroconductively interconnected within the electrical connecting structure.

An electrical unit is understood to be an electrical consumer or an electrical energy source. The electrical lines may have a cross section of 25 to 50 mm², for example, and, at a cross section of 35 mm², are adapted for transmitting 150 A per line, for example. On the one hand, electromagnetic interference is induced into the electrical conductor by the inverter. On the other hand, the electrical conductor itself generates electromagnetic interference due to magnetic induction. The first and the second electric current may be an AC current supplied by an energy source, for example. The first and the second current may also be pulsed DC current, it being possible for the pulsed DC current to be produced by an inverter and/or in response to the fluctuating power demand of electrical consumers, such as electric motors. Accordingly, electromagnetic interference or interference currents may not only occur in an electrically conductive connection of the inverter to an electrical consumer, but also in an electrically conductive connection of the inverter to a direct current source, such as a vehicle battery, for example. An electrical unit may be an electrical consumer, a battery, a DC-DC converter or also a charging module for the battery, for example. The idea underlying the present invention is that the electrically conductive connection of the first and second shield within the electrical connecting structure, this being provided in the electrical connector or at least in the vicinity thereof, couples the electromagnetic interference of the first conductor into the second shield of the second electrical conductor and vice versa. Thus, ideally, the electromagnetic interference generated by a source of interference, for example, the inverter, and conducted along the first conductor due to the temporal phase shift, respectively the first shield extending in parallel to the first conductor, to the electrical connector, respectively the connector housing thereof, may be coupled into the second shield and fed back along the second conductor, respectively the second shield extending in parallel to the second conductor, to the source of interference. Thus, theoretically, the interference current present in the first shield would not cause any power losses to occur in the electrical plug connection that would result in heat being input into the electrical plug connection, thus into the electrical connector and/or the electrical mating connectors. Due to deviations from the ideal case, for example, due to the temporal offset of the phases not exactly corresponding to the fraction of 360°, the current intensities to be transmitted to the drive motor changing, or transition resistances being present upon detachable connection of the individual shields, it is not possible for the entire interference current of the first shield to be conducted into the second shield; rather a portion of this interference current is still carried through the connector housing to a ground of the electrical unit. The result is a substantially lower power loss. The maximum total heat load that the electrical plug connection may be subjected to is composed of the ambient temperature in which the electrical plug connection is operated, the heating of the electrical conductor caused by the current intensities, and the heating generated by the power loss in the shields. Thus, the heat saved in comparison to the related art due to the reduced power loss may be utilized, for example, for transmitting a higher current via the specified electrical conductor. The heat saved in comparison to the related art may also be utilized for operating the electrical connector at a higher ambient temperature. The electrical connector generally features a connector housing that is fabricated of electrically non-conductive plastic.

In accordance with another exemplary embodiment of the present invention, the first shield and the second shield are electroconductively interconnected outside of the electrical connector.

Thus, most of the interference current caused by the inverter and induced into the shield of the electrical conductor is not directed through the electrical conductor. Merely a small portion of the interference current is conducted into the electrical unit. The power loss in the form of heat in the plug connection is thereby significantly reduced.

In accordance with another exemplary embodiment of the present invention, the first shield and the second shield are electroconductively interconnected close to the entry thereof into the electrical connector.

Due to the proximity of the electrically conductive connection of the first shield and the second shield to the electrical connector, virtually no electromagnetic interference currents are able to be induced into the shield of the electrical connector through the electrical line portion remaining between the electrically conductive connection and the electrical connector.

In accordance with another exemplary embodiment of the present invention, the first shield and the second shield are electroconductively interconnected within the electrical connector.

Such a structural design readily allows the first shield and the second shield, for example, to be electroconductively interconnected.

In accordance with another exemplary embodiment of the present invention, an electrical configuration is provided with an electrical connecting structure described in the preceding.

The electrical connecting structure electroconductively interconnects an inverter and an electrical unit.

In accordance with another exemplary embodiment of the present invention, the electrical connecting structure of the electrical configuration has a first electrical plug connector having a first electrically insulating connector housing, and a second electrical plug connector having a second electrically insulating connector housing. The first electrical connector is electroconductively connected to the electrical unit. The second electrical connector is electroconductively connected to the inverter. The first shield and the second shield are electroconductively interconnected twice.

In the case of the first connector, the electrically conductive connection may be established within or outside of the connector housing and, in the case of the second connector, likewise within or outside of the connector housing thereof. When the electrically conductive interconnection of the first shield and of the second shield is established outside of the connector housing, each electrically conductive connection is then configured close to the entry of the lines into the particular connector.

In accordance with another exemplary embodiment of the present invention, a motor vehicle is provided with an electrical configuration as described in the preceding.

It is noted that ideas pertaining to the present invention are described herein in the context of an electrical connecting structure, an electrical configuration having such a connecting structure, and a motor vehicle having an electrical configuration. It is evident to one skilled in the art that each of the described features may be combined with one another in different ways in order to thereby arrive at other embodiments of the present invention.

### BRIEF DESCRIPTION OF THE DRAWINGS

Specific embodiments of the present invention are described in the following with reference to the figures. The figures are merely shown schematically and are not true-to-scale.

FIG. 1 shows a longitudinal section through a conventional electrical connecting structure that is connected to an electrical consumer.

FIG. 2 shows the shield of FIG. 1 as an equivalent electrical circuit diagram.

FIG. 3 shows a first variant of an electrical connecting structure in a longitudinal section.

FIG. 4 shows a longitudinal section of the first variant of the electrical connecting structure connected to the electrical consumer.

FIG. 5 shows the shield known from FIG. 4 as an equivalent electrical circuit diagram.

FIG. 6 shows a longitudinal section of a second variant of the electrical connecting structure connected to the electrical consumer.

FIG. 7 shows the shield of FIG. 6 as an equivalent electrical circuit diagram.

FIG. 8 shows a motor vehicle having a direct current source, an inverter and a drive motor, as well as an electrical connecting structure that connects the inverter and the drive motor.

### DETAILED DESCRIPTION OF EXAMPLE EMBODIMENTS

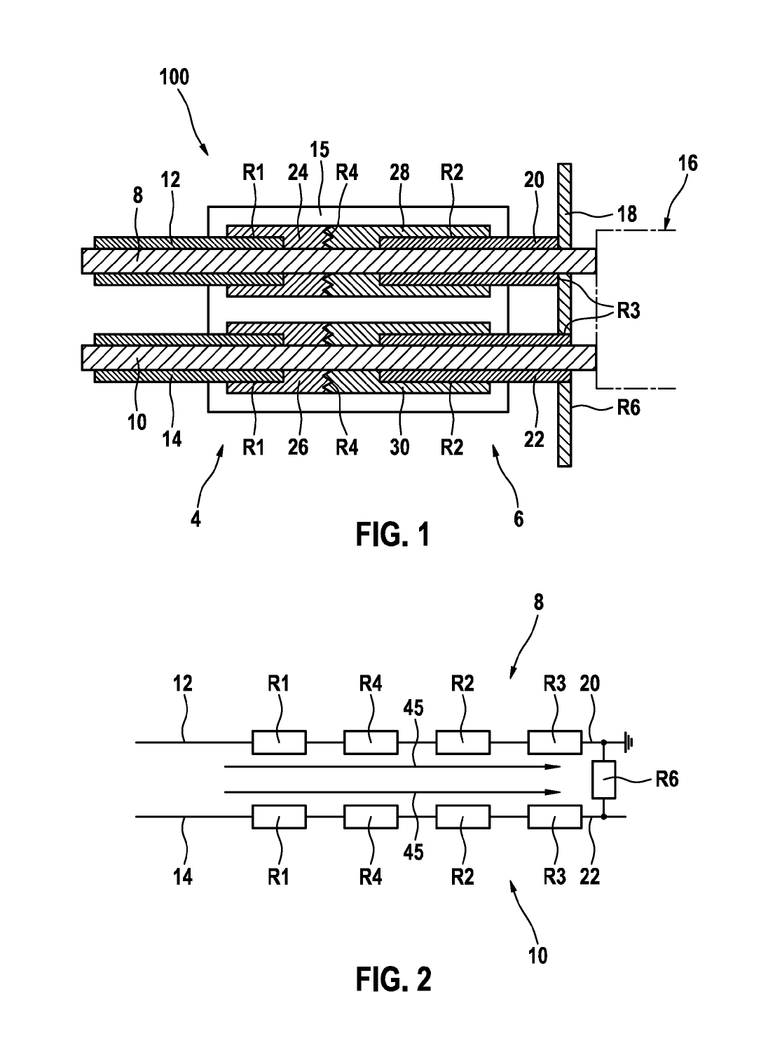

FIG. 1 shows a conventional electrical connecting structure 100. In this case, electrical connecting structure 100 has an electrical connector 4 having an electrically insulating connector housing 15 that is detachably connected to an electrical mating connector 6. The connecting structure 100 has a first electrical line 8, first electrical line 8 being adapted for transmitting a first electric current at a first phase angle. Connecting structure 100 also has a second electrical line 10 that is adapted for transmitting a second electric current at a second phase angle. In this case, the first phase angle and the second phase angle are temporally offset from one another. First line 8 has a first shield 12 for protecting against electromagnetic interference. Second line 10 has a second shield 14 for protecting against electromagnetic interference. First electrical line 8 and second electrical line 10 are routed to an electrical unit 16 constituted as an electrical consumer. Electrical unit 16 is supplied with electrical energy via these two electrical lines 8, 10. Electrical unit 16 is surrounded by an electrically conductive unit housing 18. Electroconductively connected to unit housing 18 are a third shield 20 and a fourth shield 22. Third shield 20 and fourth shield 22 extend into electrical mating connector 6. Electrical mating connector 6 may be permanently connected to unit housing 18. In electrical connector 4-mating connector 6-combination, first shield 12 is electroconductively connected to third shield 20, and second shield 14 to fourth shield 22. To this end, first shield 12 is electroconductively connected to a first shield component 24, and second shield 14 to a second shield component 26, first 24 and second shield component 26 being components of electrical connector 4. Third shield 20 is electroconductively connected to a third shield component 28, and fourth shield 22 to a fourth shield component 30. In this case, third 28 and fourth shield component 30 constitute a component of electrical mating connector 6. Thus, first shield component 24 is connected to third shield component 28, and second shield component 26 to fourth shield component 30, in each case electroconductively and detachably to one another. A first transition resistor R1 is provided in each case at the transition from first shield 12 to first shield component 24, respectively from second shield 14 to second shield component 26. A second transition resistor R2 is provided in each case at the transition from third shield 20 to third shield component 28, respectively from fourth shield 22 to fourth shield component 30. In addition, a third transition resistor R3 is present in each case at the transition from unit housing 18 to third 20, respectively fourth shield 22. In addition, a fourth transition resistor R4 is present at a transition of first 24 to third shield component 28, respectively of second 26 to fourth shield component 30. In addition, unit housing 18 has a resistor R6. In the exemplary embodiment shown here, electrical lines 8, 10 have a cross section of 35 mm² and are each supplied with approximately 150 A. The current is fed through an inverter (not shown here) into both lines 8, 10. The inverter produces electromagnetic interference which is likewise induced into shields 12, 14. Due to this induction, as well as the high currents in the lines, which induce magnetic interference in shields 12, 14, 20, 22, in total, up to 70 A interference current may be induced in shields 12, 14, 20, 22.

FIG. 2 shows the shield of FIG. 1 as an equivalent electrical circuit diagram. Unit housing 18 is depicted as ground. It is readily apparent that transition resistors R1, R2, R3, R4 are connected in series, both for first 12 and third shield 20, as well as for second 14 and fourth shield 22.

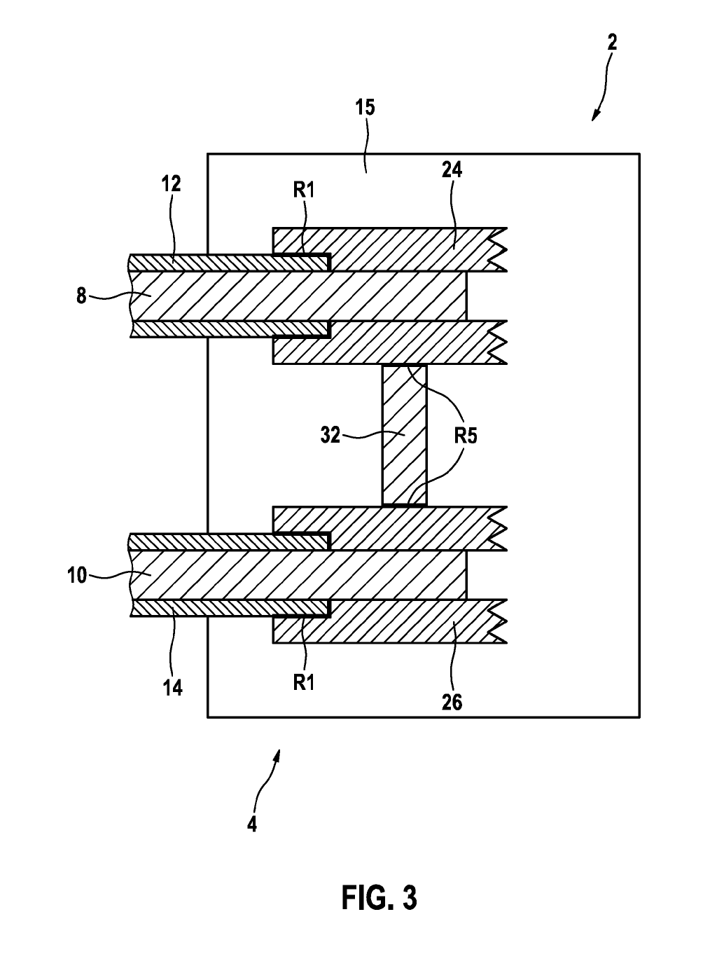

FIG. 3 shows a first variant of an electrical connecting structure 2. In this case, electrical connector 4 shown here differs from the one shown in FIG. 1 in that first shield component 24 and second shield component 26 are electroconductively interconnected within electrical connector 4 by connection 32. There is a fifth transition resistor R5 in each case between connection 32 and first 12, respectively second shield 14.

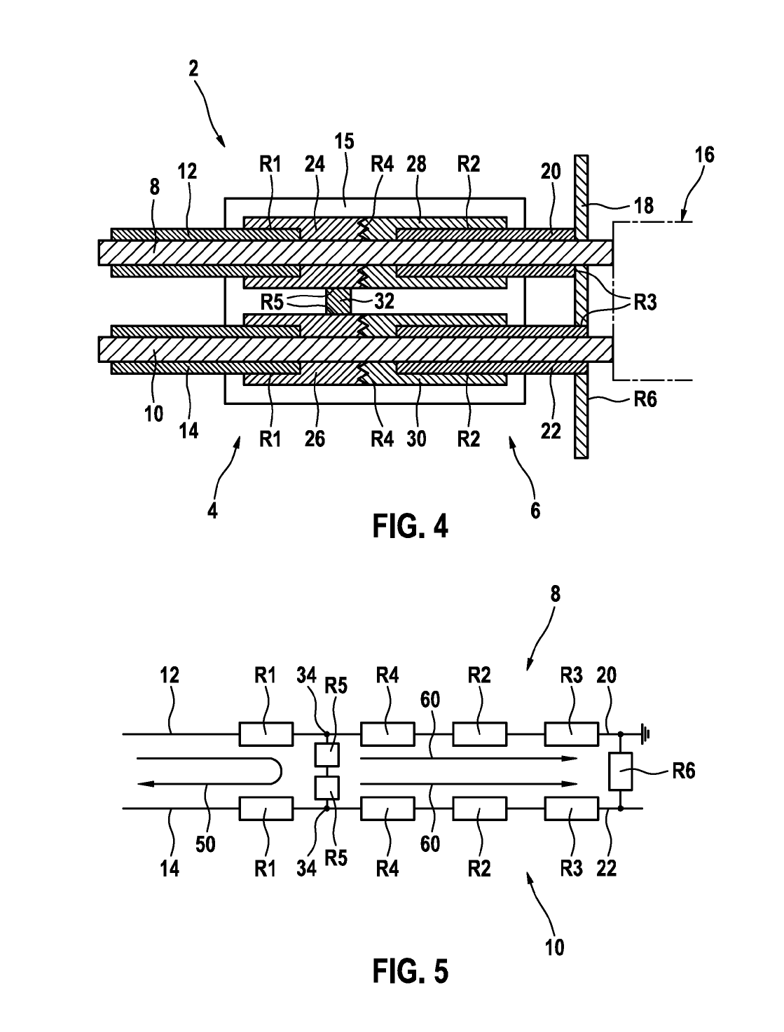

FIG. 4 shows the representation of FIG. 1 with connector 4 being replaced by connector 4 of FIG. 3. Accordingly, first shield component 24 and second shield component 26 are electroconductively connected by connection 32.

FIG. 5 shows the shield of FIG. 4 as an equivalent electrical circuit diagram. Two current paths 50, 60 are clearly represented here. First current path 50 leads from first shield 12 via transition resistor R1 to a branch connection 34 into two transition resistors R5 and, from there, into first transition resistor R1 to second shield 14. From branch connection 34, a second current path 60 for first conductor 8 leads into fourth transition resistor R4; from there, into second transition resistor R2; from there, into third transition resistor R3; and, from there, into third shield 20. As previously explained, currents of up to 70 A, for example, are induced into first shield 12. Thus, current of a magnitude of 70 A flows in first current path 50. Due to electric asymmetries, second current path 60, which leads from the branch connection into fourth transition resistor R4, as well as into further transition resistors R2 and R3, is supplied with significantly lower currents of approximately 5 A, for example. Second current path is provided for each electrical line 8, 10 and, thus, twice in the exemplary embodiment described here. Thus, the total power loss occurring in the combination shown here of electrical connector 4 and electrical mating connector 6 may be calculated for first 50 and second current path 60. Due to the significantly lower current intensities, a likewise significantly reduced power loss occurs in current path 60 in comparison with the total power loss occurring in electrical connection structure 100 of the related art.

This makes it clear that, by creating two current paths 50, 60, the interference current introduced through shield 12 into electrical connector 4-mating connector 6-combination is diverted virtually losslessly via third shield 14 from electrical connector 4-mating connector 6-combination. The electrically induced interference currents incoming in first shield 12 may be directed by second shield 14 back to a producer.

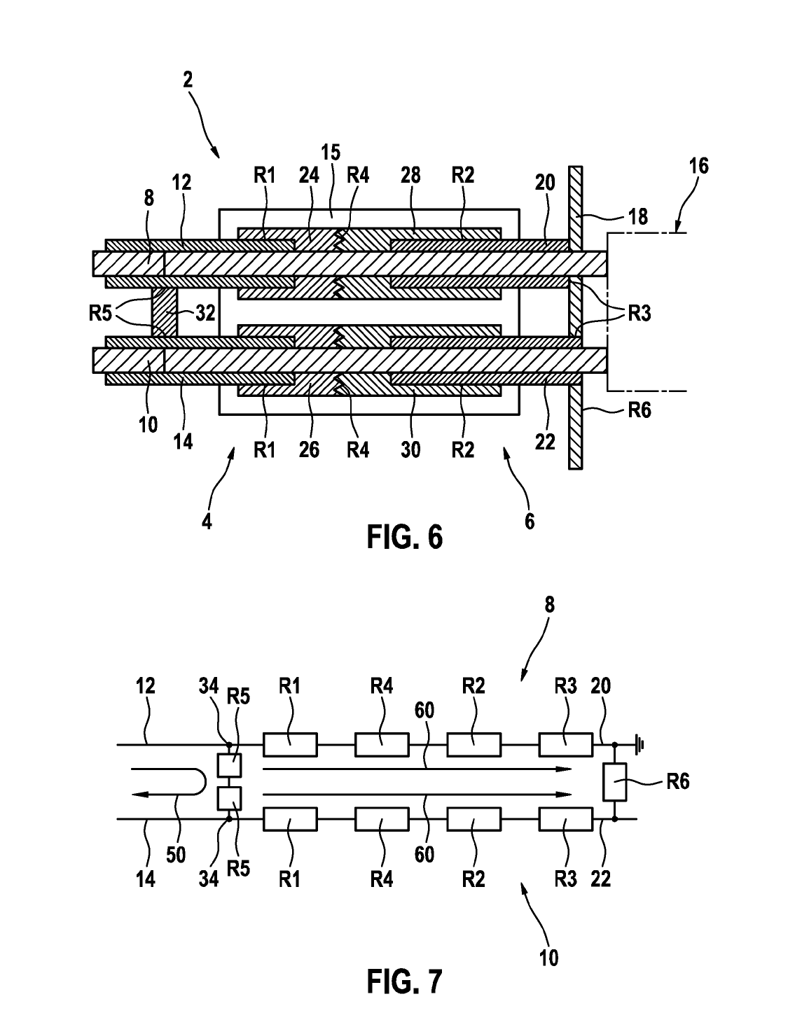

FIG. 6 differs from FIG. 4 in that electrically conductive connection 32 between first shield 12 and second shield 14 is already established near the entry thereof into electrical connector 4-mating connector 6-combination.

FIG. 7 shows the shield of FIG. 6 as an equivalent electrical circuit diagram. Accordingly, branch connection 34 is already provided upstream of first transition resistor R1.

In accordance with the preceding description, there are also two current paths 50, 60 here. However, since first current path 50, generally composed of the two fifth transition resistors R5, is situated outside of electrical connector 4-mating connector 6-combination, first current path 50 does not contribute to a power loss within electrical connector 4-mating connector 6-combination. As already described, downstream of branch connection 34, transition resistors R1, R4, R2 and R3 are merely acted upon by a significantly lower current intensity of approximately 5 A, for example. Accordingly, the power loss arising in the electrical connector 4-mating connector 6-combination is reduced in comparison to conventional connectors.

Since the power losses also lead to a heating of the electrical connector 4-mating connector 6-combination, given a correspondingly lower power loss, this electrical connector 4-mating connector 6-combination is also heated less. At this point, assuming that the electrical connector 4-mating connector 6-combination may be operated at a predetermined temperature, the lower heat produced by the lower power loss may then be utilized, for example, for increasing the current intensities transmitted by electrical lines 8, 10. The lower heat input produced by the power loss may also be utilized for operating the electrical connector 4-mating connector 6-combination at a higher ambient temperature.

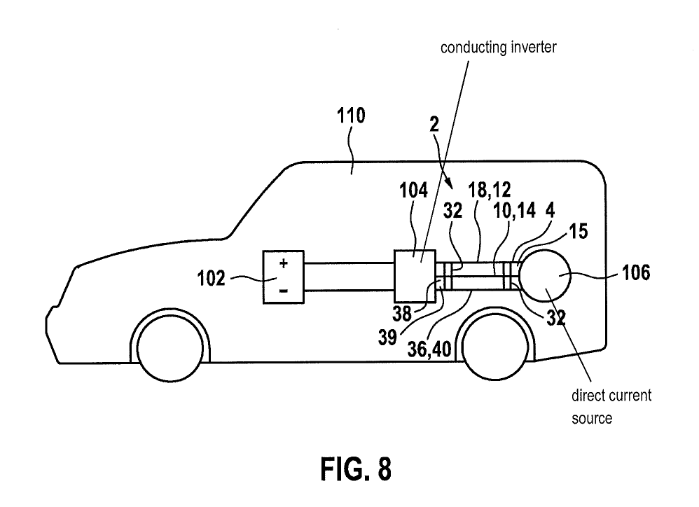

FIG. 8 shows a motor vehicle 110. A DC voltage source 102 is electroconductively connected to an inverter 104. In this exemplary embodiment, DC current is converted by inverter 104 into a three-phase AC current. This three-phase AC current is fed by electrical connecting structure 2 to an asynchronous motor 106 that drives motor vehicle 110. Besides first line 6 and second line 8, electrical connecting structure 2 has a third line 36. In addition, electrical connecting structure 2 has a second electrical connector 38 having a second electrically insulating connector housing 39 via which electrical connecting structure 2 is electroconductively detachably connected to inverter 104. Besides first 12 and second shield 14, third electrical line 36 also has a third shield 40. Shields 12, 14, 40 are electroconductively interconnected by connection 32, both within first connector 4, as well as within second electrical connector 38. This electrical connecting structure 2 may also be used for connecting inverter 104 to direct current source 102.

1-7. (canceled)

8. An electrical connecting structure, comprising:
an electrical connector having an electrically insulating connector housing, the electrical connecting structure being adapted for electroconductively connecting the electrical connector to an electrical mating connector that is permanently connected to an electrical unit to permit the transmission of high currents;
a first electrical line adapted for transmitting a first electric current at a first phase angle; and
a second electrical line adapted for transmitting a second electric current at a second phase angle, the first phase angle and the second phase angle being temporally offset from one another;
wherein the first line has a first shield for protecting against electromagnetic interference, the second line has a second shield for protecting against electromagnetic interference, the first shield being detachably and electroconductively connectable to a third shield configured in the mating connector, the second shield being detachably and electroconductively connectable to a fourth shield configured in the mating connector, the first shield and the second shield differ from one another, and wherein the first shield and the second shield are electroconductively interconnected within the electrical connecting structure.

9. The electrical connecting structure as recited in claim 8, wherein the first shield and the second shield are electroconductively interconnected outside of the electrical connecting structure.

10. The electrical connecting structure as recited in claim 8, wherein the first shield and the second shield are electroconductively interconnected close to an entry thereof into the electrical connecting structure.

11. The electrical connecting structure as recited in claim 8, wherein the first shield and the second shield are electroconductively interconnected within the electrical connector.

12. An electrical configuration, comprising:
an electrical connector having an electrically insulating connector housing, the electrical connecting structure being adapted for electroconductively connecting the electrical connector to an electrical mating connector that is permanently connected to an electrical unit, to permit the transmission of high currents, a first electrical line adapted for transmitting a first electric current at a first phase angle, and a second electrical line adapted for transmitting a second electric current at a second phase angle, the first phase angle and the second phase angle being temporally offset from one another, and wherein the first line has a first shield for protecting against electromagnetic interference, the second line has a second shield for protecting against electromagnetic interference, the first shield being detachably and electroconductively connectable to a third shield configured in the mating connector, the second shield being detachably and electroconductively connectable to a fourth shield configured in the mating connector, the first shield and the second shield differ from one another, and wherein the first shield and the second shield are electroconductively interconnected within the electrical connecting structure; and
an inverter and an electrical unit, the electrical connection structure interconnecting the inverter and the electrical unit.

13. The electrical configuration as recited in claim 12, wherein the electrical connecting structure has a first electrical connector having a first electrically insulating connector housing and a second electrical connector having a second electrically insulating connector housing, the first electrical connector being electroconductively connected to the electrical unit, the second electrical connector being electroconductively connected to the inverter, and the first shield and the second shield being electroconductively interconnected twice.

14. A motor vehicle, comprising:
an electrical configuration including an electrical connector having an electrically insulating connector housing, the electrical connecting structure being adapted for electroconductively connecting the electrical connector to an electrical mating connector that is permanently connected to an electrical unit, to permit the transmission of high currents, a first electrical line adapted for transmitting a first electric current at a first phase angle, and a second electrical line adapted for transmitting a second electric current at a second phase angle, the first phase angle and the second phase angle being temporally offset from one another, and wherein the first line has a first shield for protecting against electromagnetic interference, the second line has a second shield for protecting against electromagnetic interference, the first shield being detachably and electroconductively connectable to a third shield configured in the mating connector, the second shield being detachably and electroconductively connectable to a fourth shield configured in the mating connector, the first shield and the second shield differ from one another, and wherein the first shield and the second shield are electroconductively interconnected within the electrical connecting structure, and an inverter and an electrical unit, the electrical connection structure interconnecting the inverter and the electrical unit.
